(19) United States
(12) Patent Application Publication
(10) Pub. No.: US 2009/0299960 A1
(43) Pub. Date: Dec. 3, 2009

(54) METHODS, SYSTEMS, AND COMPUTER PROGRAM PRODUCTS FOR AUTOMATICALLY MODIFYING A VIRTUAL ENVIRONMENT BASED ON USER PROFILE INFORMATION

(76) Inventor: William B. Lineberger, Cary, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/962,988

(22) Filed: Dec. 21, 2007

(51) Int. Cl. G06F 3/01; G06F 17/30

(52) U.S. Cl. 707/3; 715/745; 707/E17.014; 715/757

(57) ABSTRACT

The subject matter described herein includes methods, systems, and computer program products for automatically modifying a virtual environment based on user profile information. According to one aspect, the method includes determining user profile information associated with a user and automatically modifying a virtual environment based on the determined user profile information, wherein automatically modifying the virtual environment includes automatically modifying at least one non-advertising element of the virtual environment.

### TECHNICAL FIELD

The subject matter described herein relates to virtual environments. More particularly, the subject matter described herein relates to methods, systems, and computer program products for automatically modifying a virtual environment based on user profile information.

### BACKGROUND

A virtual environment is a computer simulation of an environment, whether real or imaginary, that allows a user to interact with the virtual environment through the use of a variety of interfaces. A virtual environment is typically experienced by a user via a display and speakers so that visual and auditory elements are represented to the user. However, virtual environments may provide other types of information, such as haptic information (i.e. force feedback), to the user as well. Interaction with the virtual environment may be accomplished via manipulation of a conventional keyboard/mouse combination or may include a variety of other input devices, such as gloves, touchscreens, microphones, musical instruments, dance mats, etc.

Virtual environments may be divided into several categories based on their properties in relation to the user. For example, some multiple virtual environments may be created and operated independently (i.e. single player mode or offline mode) or, alternatively, a single virtual environment may be simultaneously shared by multiple users. Virtual environments may also be categorized as either “persistent” or “non-persistent,” where a persistent virtual environment is a virtual environment that continuously exists regardless of whether users are connected to the environment. A non-persistent environment includes a virtual environment that is created or destroyed each time a user or group of users enters the environment. Popular examples of persistent online virtual environments include so-called massively multiplayer online role playing games (MMORPGs), such as World of Warcaft™ produced by Blizzard, Inc., of Irvine, Calif., and Second Life™ produced by Linden Research, Inc., of San Francisco, Calif.

One problem associated with some conventional virtual environments is that modification of the environments is limited to customizing the user's avatar (i.e. clothing, jewelry, weapons, skin color, etc.), and does not allow for modifying other elements of the environment. While this limitation provides a consistent environment for a wide variety of users, it does not provide the highly customized experience desired by many users and advertisers.

For virtual environments that allow modification of the environment, the process of modifying many elements is cumbersome because it requires direct input from the user for each modification. For example, a user may manually edit configuration files, create 3-D models to substitute for existing models, replace sound files or texture files, or create custom music playlists in order to modify multiple elements of a virtual environment. Each of these examples, however, require that the user explicitly instruct the virtual environment software of the changes to the environment he or she wishes to make. Thus, for games in which a large number of changes are desired, or where changes are made at a rapid rate, the time and difficulty associated with modifying the environment increases beyond the capability of most users.

Another problem associated with conventional virtual environments is that advertising to users of virtual environments is limited in both scope and effectiveness because modifications to the environment are either limited in scope, must be performed manually, or both. For example, a virtual environment may contain a poster or billboard displaying an advertisement. The advertisement displayed may be a texture file image that is stored locally, or may be sent from a remote location (i.e. pushed) to the client computer and is viewable by the user within the virtual environment. However, just as posters or billboards may be ignored by users in a real environment, they may be similarly ignored in a virtual environment. Moreover, advertisements displayed in virtual environments are typically based on contractual agreements between advertisers and virtual environment operators. For example, an advertiser may determine through market research that players of a particular virtual environment game are primarily young men and therefore may present advertising content targeted to that demographic. Yet within the broad demographic of young men, there may be many, more specific, subcategories of users based on different preferences in music, purchase habits, etc. Accordingly, a need exists for providing a more targeted and customized user experience for users of virtual environments.

Moreover, because modification of a virtual environment based on explicit instructions from a user includes replacing one or more objects, textures, or sounds with other objects, textures, or sounds, the user must already know the item he or she wishes to substitute for the original item. This requirement makes presenting advertising to users of virtual environment users more difficult for advertising that aims to present a product or service to the user that the user has not seen before.

Accordingly, in light of the above described difficulties and needs, there exists a need for improved methods, systems, and computer program products for improved method and systems for automatically modifying a virtual environment based on user profile information.

### SUMMARY

The subject matter described herein includes methods, systems, and computer program products for automatically modifying a virtual environment based on user profile information. According to one aspect, the method includes determining user profile information associated with a user and automatically modifying a virtual environment based on the determined user profile information, wherein automatically modifying the virtual environment includes automatically modifying at least one non-advertising element of the virtual environment.

According to another aspect, a system is described for automatically modifying a virtual environment based on user profile information. The system includes user profile information module for determining user profile information associated with a virtual environment user. A virtual environment modification module automatically modifies a virtual environment based on the user profile information, wherein automatically modifying the virtual environment includes automatically modifying at least one non-advertising element of the virtual environment.

The subject matter described herein may be implemented as a computer program product comprising computer executable instructions embodied in a computer readable medium. Exemplary computer readable media suitable for implementing the subject matter described herein include disk memory devices, chip memory devices, application specific integrated circuits and programmable logic devices. In addition, a computer program product that implements the subject matter described herein may be located on a single device or computing platform. Alternatively, the subject matter described herein may be implemented on a computer program product that is distributed across multiple devices or computing platforms.

### BRIEF DESCRIPTION OF THE DRAWINGS

Embodiments of the subject matter described herein will now be explained with reference to the accompanying drawings of which:

FIG. 1 is a block diagram of a single-user system for automatically modifying a virtual environment based on user profile information according to an embodiment of the subject matter described herein;

FIG. 2 is a block diagram of an exemplary multi-user system for automatically modifying a virtual environment based on user profile information according to an embodiment of the subject matter described herein;

FIG. 3 is a flow chart of an exemplary process for automatically modifying a virtual environment based on user profile information according to an embodiment of the subject matter described herein;

FIG. 4 is a screenshot of an exemplary virtual environment suitable for being automatically modified based on user profile information according to an embodiment of the subject matter described herein; and

FIG. 5 is a screenshot of an exemplary virtual environment suitable for being automatically modified based on user profile information according to an embodiment of the subject matter described herein.

### DETAILED DESCRIPTION

The subject matter described herein includes methods, systems, and computer program products for automatically modifying a virtual environment based on user profile information. According to one aspect, a system according to the subject matter described herein may be implemented as hardware, software, and/or firmware components executing on one or more components of a system or device configured to automatically modify a virtual environment based on user profile information.

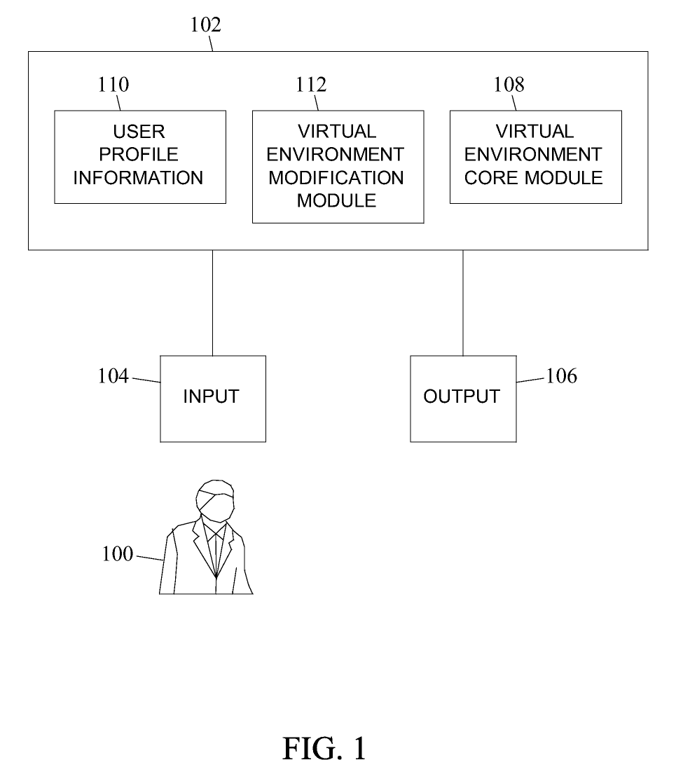

FIG. 1 is a block diagram of an exemplary system for automatically modifying a virtual environment based on user profile information according to an embodiment of the subject matter described herein. In FIG. 1, user 100 may operate client computer 102 for experiencing a virtual environment. Computer 102 may include an input device 104 such as a mouse, microphone, touchscreen, keyboard or any other suitable input means for inputting user profile information and/or interacting with a virtual environment. Computer 102 may also include an output means 106 such as a display, printer, and/or speakers for representing the virtual environment to the user. A processor and memory (not shown) may be included within computer 102 and configured to execute software code suitable for generating a virtual environment, including but not limited to an operating system, a web browser, and virtual environment software.

In the embodiment shown in FIG. 1, computer 102 may include virtual environment core module 108 for generating a virtual environment, user profile information 110 associated with a user of the virtual environment, and virtual environment modification module 112 for automatically modifying the virtual environment based on user profile information.

Virtual environment core module 108 may be configured to generate and represent a virtual environment to user 100. This may include receiving input from input 104 and displaying images and sounds to user 100 via output 106. In this way, user 100 may navigate a 3-dimensional virtual environment by controlling an avatar associated with the user and interacting with various virtual objects generated by virtual environment core module 108.

It is appreciated that computer 102 may include a personal computer (PC) for executing software code associated with rendering a virtual environment to a user. This software may include, but is not limited to, an operating system, video and sound drivers, and virtual environment core module 108. Virtual core module 108 may include any files necessary for rending a virtual environment including, but not limited to, dynamic linked libraries, maps, textures, videos, sounds, and executable files. Moreover, the responsibility for rendering a virtual environment may be distributed between computer 102 operating as a local client to user 100 and one or more remotely located virtual environment servers.

For example, in a multiplayer online game (MOG) players may connect or disconnect to a persistent virtual environment at any time by logging into or logging out of one or more game servers. Each game server may be configured to authenticate the user and may exchange instructions with virtual environment software, such as virtual environment core module 108, located on computer 102 in order to efficiently render the virtual environment simultaneously for a large number of users and maintain the integrity and synchronization of the game environment. Thus, in some embodiments, virtual environment core module 108 may include a significant portion of the data needed to render the virtual environment and store the data on computer 108 in order to minimize the amount of information transferred between computer 108 and a remote game server and in order to render the virtual environment. Accordingly, only the minimum amount of data, such as location update information and/or user input information may be transferred to server for coordination with other users sharing the virtual environment. Therefore, modification to the virtual environment generated and maintained by virtual environment core module 108 may be accomplished by modifying one or more elements on a local computer 102, a remote game server, or a combination thereof.

User profile information 110 may include any information indicating a fact, preference, or behavior associated with a user of a virtual environment. For example, user profile information may include, but is not limited to, a user's web cache, cookies, registry entries, or any other information suitable for modifying a virtual environment. For example, a user may indicate his age, gender and geographic location when registering at a favorite website. He may have also entered his favorite types of music directly via an interface of a virtual environment software program. Alternatively, or in addition to having the user directly enter preference information, the user's preferences may be gleaned from an examination of his online purchase history. This purchase history may be tracked by each of the websites from which he ordered, and this information may be stored in one or more cookies stored on computer 102. User profile information 110, therefore, may include information stored in various files and locations on computer 102 which may be aggregated and used to modify a virtual environment.

Virtual environment modification module 112 may examine user profile information 110 in order to automatically modify one or more elements of a virtual environment generated by virtual environment core module 108. At least one of the modified elements includes a non-advertising element of the virtual environment. In one example of automatically modifying a virtual environment based on user profile information, virtual environment core module 108 may generate a virtual environment including an indoor nightclub environment. In a default state, the nightclub may include bright white lighting, a jukebox not playing any music, various posters on the walls, a vending machine, non-player characters (NPCs), furniture, etc. Virtual environment modification module 112 may automatically modify any aspect of the nightclub environment based on determined user profile information of the users within the environment. Modification of the virtual environment may include, but is not limited to, replacing files within virtual environment core module 108, renaming files, altering references to files, and editing files. It is appreciated that while virtual environment modification module 112 shown in FIG. 1 is located on computer 102 in a single-user system, virtual environment modification module 112 may also be located on a remote virtual environment server in other embodiments (i.e. MOGs) or may be divided between local and remote locations without departing from the scope of the subject matter described herein. Additionally, virtual environment modification module 112 may be incorporated into a single executable file associated with virtual environment core module 108 or may be a distinct set of computer-executable instructions.

For example, an avatar associated with a first user (hereinafter simply “first user”) may enter the nightclub environment, where the first user is associated with profile information indicating a preference for rock and roll music, generally, and grunge rock music, specifically. Profile information may further indicate that the user has previously purchased rock and roll music online. Accordingly, one or more lights, textures, models, NPCs, and sounds in the nightclub environment may be modified by virtual environment modification module 112 in order to suit the first user's preferences so that he may, for example, be more likely to purchase rock and roll-related products.

According to one aspect, virtual environment modification module 112 may modify music based on determined user profile information. For example, modification to the virtual environment may include changing the song selection or the ordering of songs available in the jukebox to rock and roll song selections. The song selections presented in the jukebox may then either be played automatically or may be selected individually by the user within the virtual environment. It is further appreciated that music selected within a virtual environment may be either simultaneously experienced (i.e. shared) by other users, or may only be heard by a single user (i.e. non-shared). Non-shared music differs from shared music in that non-shared music does not need to be identical to or in sync with the music heard by other users of a shared/non-shared virtual environment. Thus, it is appreciated that within a shared virtual environment, elements, such as music, may be non-shared.

According to another aspect, lighting effects of the nightclub environment may also be modified. For example, virtual environment modification module 112 may affect one or more lighting aspects of the virtual environment, including but not limited to, dimming the lighting, changing a lighting color may to a different hue, and/or fog/particle effects may be introduced to simulate a rock and roll show.

According to another aspect, virtual environment modification module 112 may modify texture files, whether static or dynamic, in order to suit the user's rock and roll preference. Exemplary static texture images that may be automatically modified by virtual environment modification module 112 may include a virtual poster in the nightclub, the front display on a vending machine, textures for displaying the floor (i.e. wood, carpet, etc.), textures for displaying the wall (i.e. wall paper, wall color, etc.), or the clothing of NPCs. Examples of dynamic textures may include video textures such as video displayed on a virtual television or computer screen, or displayed on a billboard. Thus, continuing the example above, poster textures may be changed to display a selection of current rock and roll bands, wall and floor textures may be changed to simulate a rock and roll club, and the clothing and physical appearance of NPCs may be changed to include rock and roll tattoos, hairstyles, and leather jackets.

According to yet another aspect, virtual environment modification module 112 may automatically modify object models based on user profile information. In a three-dimensional virtual environment, objects may be composed of texture mapped to a wireframe object model. While the appearance of an object may be altered by changing the texture alone, further changes in appearance may be achieved by modifying the object model as well. For example, a chair may be composed of a chair model and a corresponding chair texture. Thus, in order to convert a wooden arm chair suitable for placement in a jazz nightclub into a wooden barstool suitable for placement in a country/western club, virtual environment modification module 112 may modify one or more of the size, shape, or configuration of the chair object model. Additionally, an object model including multiple pieces may be separated into its component pieces in order to convey a mood within a virtual environment. For example, virtual environment modification module 112 may break a chair and a table object model into pieces by modifying the relationships between parts of the object models rather than changing the size or shape of the parts as described above.

According to another aspect, objects within the virtual environment may be interactive, either to information located within the virtual environment or to external information, such as a web page. Moreover, interactive elements modified by virtual environment modification module 112 may be either commercial (i.e. advertising) or non-commercial (i.e. fan sites, encyclopedias, etc.) in nature.

For example, the exemplary rock and roll user described above may view a poster on the wall of the virtual nightclub displaying a new rock and roll band being promoted by an advertiser. The user may click on the poster and read additional information about the band within the interface of the virtual environment. Alternatively, clicking on the poster may send the user to a webpage for more information, thereby leaving the virtual environment. This allows advertisers the ability to share information with a wide variety of virtual environment users without having to incur the time and expense of formatting the information for each virtual environment software program. Furthermore, the webpage delivered to the user may differ based on his user profile information. The user's profile information may, for example, indicate that he has rarely purchased music online and prefers to read song lyrics, concert dates, band photographs, or guitar tablature. Such a user may therefore be sent to a fan website when he clicks on the band's poster in the virtual environment. However, a different user's profile information may indicate a high purchase rate for online music. This type of user, therefore, may instead be directed to a commercial webpage to make music a purchase. Thus, external locations linked to objects within the virtual environment may be tailored to suit a user's interests based on their profile information.

According to another aspect, different types of user profile information may be weighed differently in determining how/when to modify the virtual environment. For example, a music preference of a user may be assigned a point value (1 point), whereas a music purchase may be assigned a higher value (3 points). Similarly, varying point values may be assigned to each type of user profile information in order to balance and adjust the types of behaviors and/or information that is rewarded in the virtual environment.

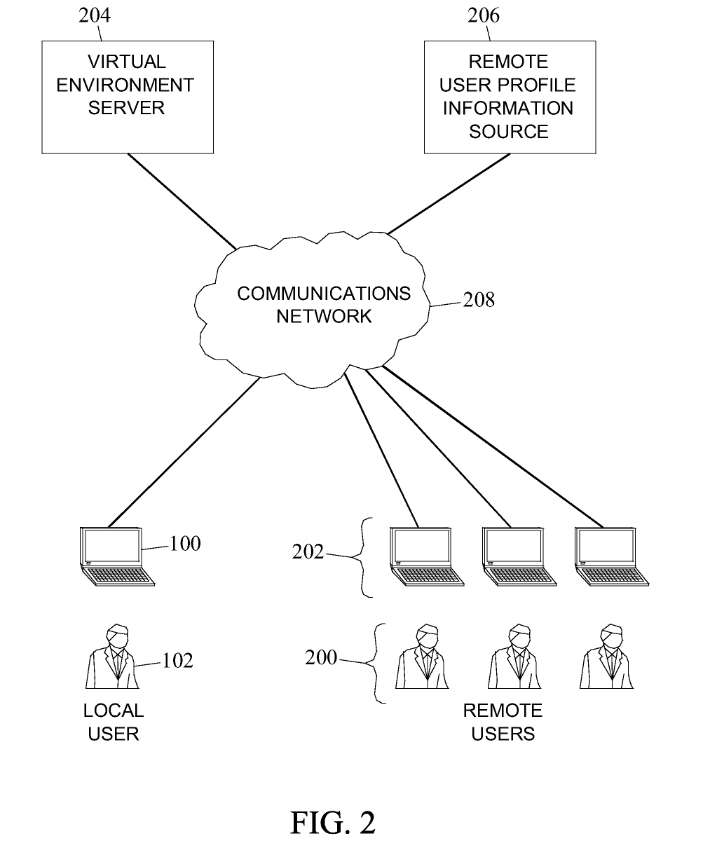

In another embodiment, the virtual environment may be shared by multiple users. FIG. 2 illustrates an exemplary system for supporting multiple users of a shared virtual environment. In FIG. 2, each of client computers 100 and 202 may execute client-side software associated with the virtual environment. Client computers 100 and 202 may be connected to each other via network 208 as well as to a virtual environment server 204 executing server-side software and, optionally, a remote user profile information source 206. It is appreciated that in addition to local user profile information, remotely located user profile information 206 may also be used to modify a virtual environment of a user. Remote user profile information 206 may include information relating to the user's purchase history, music preference, age, gender, etc. that is stored at a server remote from client. For example, one of users 200 may subscribe to an online music service that is configured to track the songs belonging to the user's music library, which songs are played, the time songs are played, how often each song is played, etc. This information may be stored on a server which is accessible via a web browser, such as remote user profile information source 206. Thus, in order to obtain a complete set of user profile information, client 100 or virtual environment server 204 may query remote user profile information source 206 to obtain remote user profile information.

In a shared virtual environment, one method for determining the user profile information for automatically modifying the virtual environment may include using user profile information shared by a majority of the users located in the environment at a particular time. For example, continuing the nightclub example described above wherein the nightclub was modified based on user profile information associated with a first user, a second and a third user may then enter the nightclub environment, where both the second and third users share the same profile information as the first user, namely, a preference for grunge music. Because the virtual environment was already optimized for this music preference based on the user profile information associated with the first user, no further modification to the nightclub environment is necessary based on the addition of the second and third users.

However, a fourth user may enter the nightclub whose associated user profile information is different from the first, second, and third users. Specifically, the fourth user's profile information may indicate a preference for jazz music. However, because the fourth user's preferences do not constitute a majority of those in the nightclub (i.e. 3 to 1), the nightclub environment would remain unchanged.

Next, another group consisting of five additional users enters the nightclub, and all five users' profile information indicates a preference for hip hop music, a new majority preference would exist (5 to 3 to 1) and the nightclub may be altered to suit the majority's hip hop music preference. For example, the songs on the jukebox, the posters on the wall, etc. may all be modified by virtual environment modification module 112 to include hip hop related materials.

It is appreciated that the number of modifications, or transitions, to the virtual environment may be limited in order to prevent an excessive number of transitions from occurring that may have a disorienting effect on users. For example, the number of transitions may be limited to N times per minute.

In another embodiment, the virtual environment may include a shared experience or activity, in addition to a shared environment. The nature of the shared activity may change based on the composition of the group and its associated user profile information. For example, a group of users may meet in a common virtual location for the purpose of completing a task, or “quest”. The moderator of the activity may be embodied in an NPC dedicated to that task, namely an activity coordinator or “quest giver”.

Exemplary activities that may be shared by a group of users may include an action game (i.e. a hostage rescue mission) or a social activity, such as a poolside chat or concert. For a group of users, an activity coordinator may create a specialized environment for performing an activity based on the users' profile information. Therefore, if profile information associated with a first group of users indicates a preference for similar types of activities, similar purchase histories, etc., a meeting room may be modified to reflect action oriented themes and may contain advertising links for purchasing new releases of other action games. Similarly, if the profile information of a second group of users indicates that a shared interest in a particular band or type of music, then a concert environment may be created for that type of music.

According to another aspect of the concert example described above, large shared experiences, such as virtual outdoor concerts may be modified based on the aggregate profile information of the group. For example, a concert may be viewed by a group of users identifiable as three distinct groups based on a portion of their profile information: users who prefer western films, users who prefer science fiction films, and users who prefer action films. During the concert, there may be various intermissions, or other temporary pauses in the main musical performance (i.e. to change sets, switch acts, etc.). During these breaks, video clips may be played for the crowd that may include advertisements such as movie trailers. Based on a continuous or periodic sampling of the user profile information of the audience, virtual environment modification module 112 may play different types of clips during concert breaks. Additionally, applications which are specifically suited to virtual environments may be tailored to the composition of the audience. Thus, science fiction-based flash games, puzzles, or NPCs may be part of a shared virtual experience for science fiction fans, as indicated by their user profile information.

According to another aspect, outdoor environments and/or structures may be modified based on user profile information. For example, a building may be modified to include one of saloon, library, restaurant etc. by modifying both its model and its associated textures. This allows designers of virtual environments to weather various buildings or other aspects of an outdoor environment in order to appear more run down. For example, virtual environment modification module 112 may modify the goods or services sold by virtual street vendors in an outdoor shopping area and/or the ordering of items for sale may be prioritized based on user preferences, purchase history, advertiser payments, or otherwise customized based on a user's profile information.

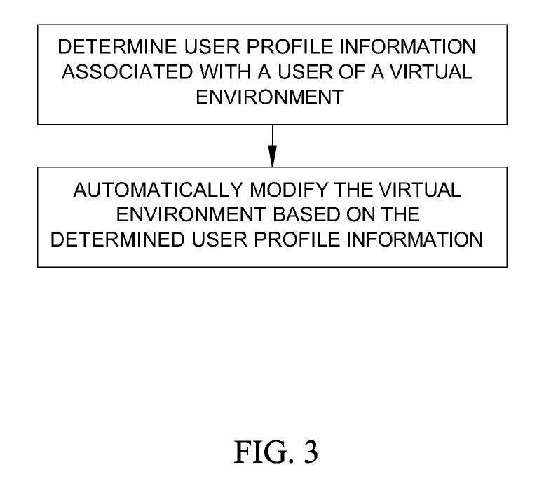

FIG. 3 is a flow chart illustrating exemplary steps for automatically modifying a virtual environment based on user profile information according to an embodiment of the subject matter described herein. Referring to FIG. 3, in block 300, user profile information is determined. Determining user profile information may include searching one or more files stored locally on a user's client computer or may include querying one or more remote user profile information sources. User profile information may include an age, gender, geographic location, music preference, or any other information suitable for modifying a virtual environment.

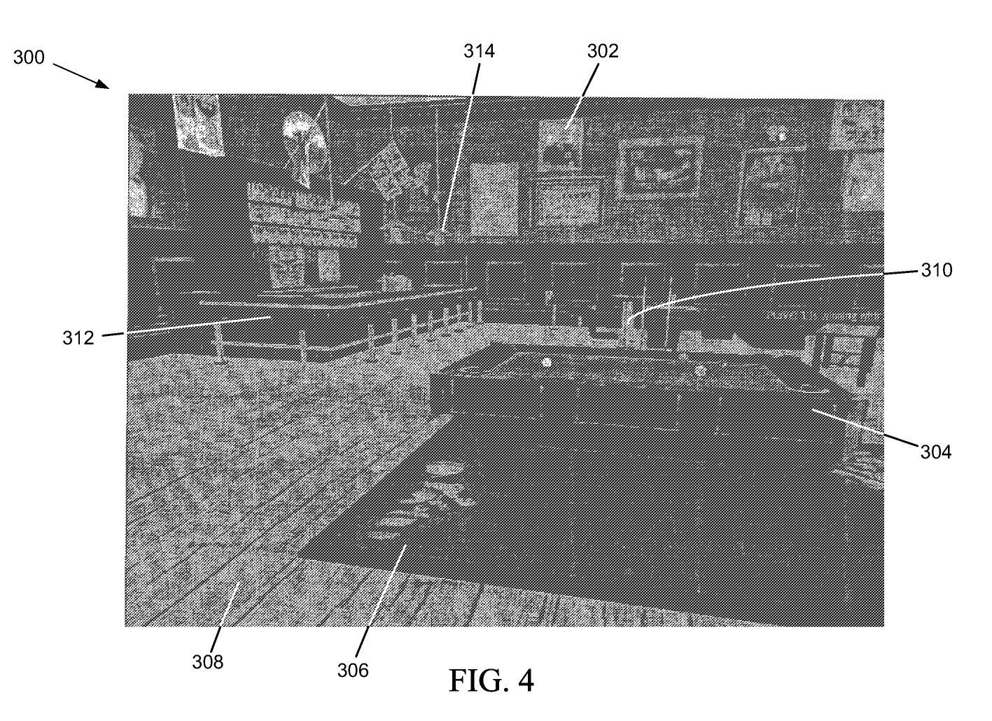

In block 302, a virtual environment is automatically modified based on determined user profile information, where at least one element to be modified includes a non-advertising element of the virtual environment. As described above, a virtual environment may include any computer generated simulation, whether representing real or imaginary environments, that may be experienced by a user through a variety of interfaces. For example, FIG. 4 illustrates an exemplary three-dimensional nightclub virtual environment capable of being experienced by a user operating suitable hardware and software. In FIG. 4, nightclub virtual environment 400 may initially include rock and roll background music, posters 402, bar 404, lights 406, pool table 408, rug 410, and furniture 412. However, the default state of nightclub 400 may be automatically modified based on determined user profile information associated with a user entering nightclub 400. Exemplary modifications may include changing poster 402 from an advertisement of a first band to an advertisement of a different band. Similarly, bar 404 and lights 406 may be modified to include different colors or intensity lights so as to be more appealing to a single user or a majority of users in nightclub 400 at a given time, as indicated by an aggregate analysis of the users' profile information. Furniture 412 may also be changed from a chair and table to a sofa or from a wooden table to a glass table, for example.

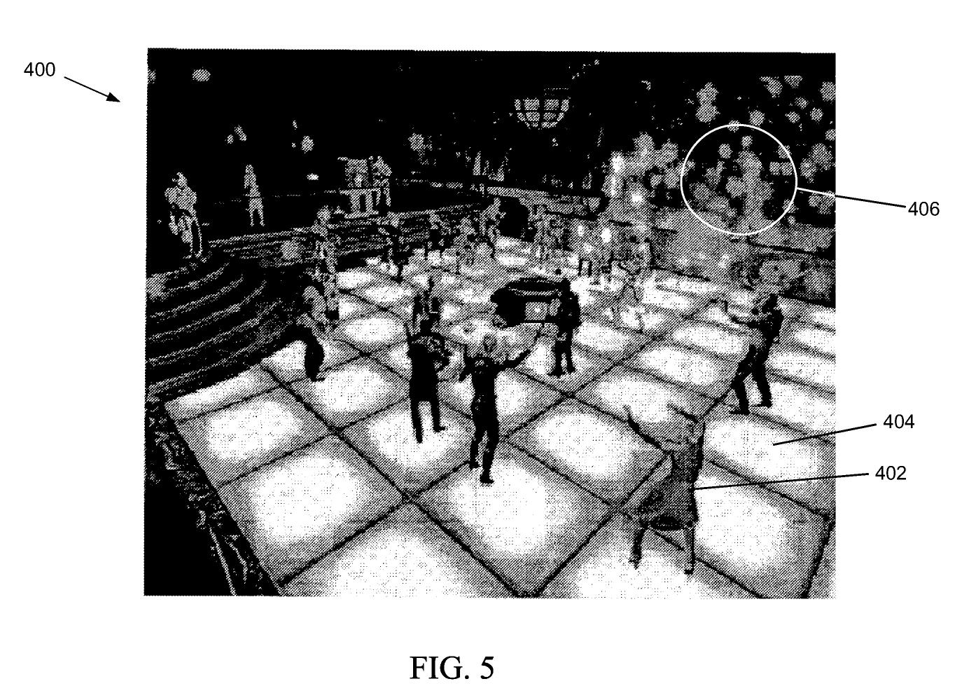

FIG. 5 is a screenshot of an exemplary virtual environment for automatically modifying a virtual environment based on user profile information according to an embodiment of the subject matter described herein. Referring to FIG. 5, a virtual dance club 500 is illustrated. Dance club 500 may include one or more NPCs 502, a lighted dance floor 504, and a particle-based lighting effect 506. It is appreciated that the any feature of NPCs 502, dance floor 504, or lights 506 may be automatically modified based on the user profile information of a user. For example, a user having profile information indicating a preference for country western music may enter dance club 500. Upon determining this preference, various aspects of NPCs 502 may be modified to include cowboy boots, hats, and denim jeans. Similarly, dance floor 504 may be automatically modified to include a wooden texture and particle effects 506 may be eliminated. Music played in dance club 500 may also be modified based on the user's profile information.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for modifying a virtual environment based on user profile information, the method comprising:
determining user profile information associated with a user of a virtual environment; and
automatically modifying the virtual environment based on the determined user profile information, wherein automatically modifying the virtual environment includes automatically modifying at least one non-advertising element of the virtual environment.

2. The method of claim 1 wherein determining user profile information includes determining profile information for one of a single user and a plurality of users.

3. The method of claim 1 wherein determining user profile information includes determining at least one of a behavior, musical preference, purchase history, age, gender, and geographic location associated with the user.

4. The method of claim 1 wherein determining user profile information includes receiving one or more of a preference and a fact associated with the user and being input by the user.

5. The method of claim 1 wherein determining user profile information includes gleaning user profile information based on a behavior of the user.

6. The method of claim 5 wherein gleaning user profile information includes one of querying a remote database and searching a web cache associated with the user.

7. The method of claim 1 wherein determining user profile information includes generating and monitoring a cookie associated with the user.

8. The method of claim 1 wherein automatically modifying a virtual environment includes modifying one of a sound, a light, a texture, and an object model in a virtual environment.

9. The method of claim 8 wherein automatically modifying a light includes automatically modifying one of a lighting brightness, a lighting color, a number of lights, and a lighting location in a virtual environment.

10. The method of claim 8 wherein automatically modifying a texture includes replacing a first texture with a second texture, wherein the second texture is different from the first texture.

11. The method of claim 10 wherein the first and second textures include one of a static image and a video and being mapped to a surface located within the virtual environment, the first and second textures being automatically modified based on the user profile information.

12. The method of claim 8 wherein automatically modifying an object model includes changing one of the size, shape, and orientation of the object model.

13. The method of claim 1 wherein automatically modifying the virtual environment includes providing a link to information external to the virtual environment, wherein the information includes one of commercial or non-commercial information.

14. A system for modifying a virtual environment based on user profile information, the system comprising:
a virtual environment for simulating a real or imaginary environment to a user; and
a virtual environment modification module for determining user profile information for a user of the virtual environment and for automatically modifying the virtual environment based on the user profile information, wherein automatically modifying the virtual environment includes automatically modifying at least one non-advertising element of the virtual environment.

15. The system of claim 14 wherein the virtual environment modification module is configured to determine profile information for one of a single user and a plurality of users.

16. The system of claim 14 wherein the virtual environment modification module is configured to determine at least one of a behavior, musical preference, purchase history, age, gender, and geographic location associated with the user.

17. The system of claim 14 wherein the virtual environment modification module is configured to receive one or more of a preference and a fact associated with the user and being input by the user.

18. The system of claim 14 wherein the virtual environment modification module is configured to glean user profile information based on a behavior of the user.

19. The system of claim 18 wherein the virtual environment modification module is configured to one of query a remote database and search a web cache associated with the user.

20. The system of claim 14 wherein the virtual environment modification module is configured to generate and monitor a cookie associated with the user.

21. The system of claim 14 wherein the virtual environment modification module is configured to modify one of a sound, a light, a texture, and an object model in a virtual environment.

22. The system of claim 21 wherein the virtual environment modification module is configured to modify one of a lighting brightness, a lighting color, a number of lights, and a lighting location in a virtual environment.

23. The system of claim 21 wherein the virtual environment modification module is configured to replace a first texture with a second texture, wherein the second texture is different from the first texture.

24. The system of claim 23 wherein the first and second textures include one of a static image and a video and being mapped to a surface located within the virtual environment, the first and second textures being automatically modified based on the user profile information.

25. The system of claim 21 wherein the virtual environment modification module is configured to change one of the size, shape, and orientation of the object model.

26. The system of claim 14 wherein the virtual environment modification module is configured to provide a link to information external to the virtual environment, wherein the information includes one of commercial or non-commercial information.

27. A computer readable medium containing a computer program, executable by a processor, the computer program comprising executable instructions for:
determining user profile information associated with a user of a virtual environment; and
automatically modifying the virtual environment based on the user profile information, wherein automatically modifying the virtual environment includes automatically modifying at least one non-advertising element of the virtual environment.
